(19) United States
(12) Patent Application Publication
(10) Pub. No.: US 2015/0130939 A1
(43) Pub. Date: May 14, 2015

(54) Universal mobile video surveillance system and method for convenient operation in a truck

(71) Applicant: John Patrick Moulton, Orlando, FL (US)

(72) Inventor: John Patrick Moulton, Orlando, FL (US)

(21) Appl. No.: 14/177,168

(22) Filed: Feb. 10, 2014

Related U.S. Application Data
(60) Provisional application No. 61/902,725, filed on Nov. 11, 2013.

(51) Int. Cl. B60R 11/04; H04N 7/18

(52) U.S. Cl. CPC B60R 11/04; H04N 7/185; B60R 2011/004
USPC 348/148

(57) ABSTRACT

A universal mobile video surveillance system for convenient mounting in a truck or other vehicle with a flat bed, can include a sled, leveling jacks, mounted externally via outriggers to the four corners of the sled, and a surveillance mast, which can further include a sensor unit, which for example can be a video recording unit, optionally also fitted with lighting and audio recording capability. The design, using leveling jacks with caster wheels, can allow one operator to move the surveillance system onto and off the bed of a truck. A method for transferring a mobile video surveillance system onto the bed of a truck can include lifting the leveling jacks, placing the bed of a truck under the sled, which is carrying the surveillance mast, and then lowering the leveling jacks and securing the sled to the truck, using tie-down components that attach to mounts in the truck bed.

### CROSS-REFERENCE TO RELATED APPLICATIONS

This application claims the benefit of U.S. Provisional Application No. 61/902,725, filed Nov. 11, 2013.

### FIELD OF THE INVENTION

The present invention relates generally to the field of mobile mast surveillance systems.

### BACKGROUND OF THE INVENTION

Mast mounted video surveillance systems for installation in trucks or other vehicles are well known, and are in common use for a variety of applications, for example in media reporting, security and law enforcement.

Such systems can provide effective means for mobile surveillance, but can be difficult to install and operate. In most cases, moving such as system from one vehicle to another is a time consuming and complex process.

As such, considering the foregoing, it may be appreciated that there continues to be a need for novel and improved devices and methods for mast mounted surveillance systems that allow easy installation in trucks and other vehicles.

### SUMMARY OF THE INVENTION

The foregoing needs are met, to a great extent, by the present invention, wherein in aspects of this invention, enhancements are provided to the existing devices and methods to install and operate surveillance systems mounted on trucks and other vehicles.

In an aspect, a universal mobile video surveillance system for convenient mounting in a truck or other vehicle can include a sled, leveling jacks, and a surveillance mast, which can further include a sensor unit, such as a video camera.

In a related aspect, the recording unit in the form of a video camera can optionally also be fitted with lighting and audio recording capability, or some other type of sensor, such as a radar.

In a related aspect, the surveillance mast can further include a guard, which can protect the sensor unit during transportation, when the mast structure is retracted.

In a related aspect, the universal mobile video surveillance system can be positioned on the ground with the sled lifted from the ground by extension of the leveling jacks, so a truck can be backed up to position the surveillance system in the bed of the truck, whereby thereafter the leveling jacks can be lowered to secure the surveillance system in the truck bed.

In a further related aspect, the leveling jacks can be mounted with caster wheels so one single operator can roll the surveillance system in position in the bed of a truck.

In a related aspect, the leveling jacks can be controlled wirelessly or via an attached control wire, and can contain a manual, electrical, or mechanical lifting mechanism.

In related aspects, the mast can be constructed from well-known and generally available telescopic mast systems. The mast may employ different types of mechanical mechanisms to extend or retract the mast, and can be constructed as a telescopic lattice structure, a pump-up structure, or other common telescopic mast structures, and may further be remote controllable via a wireless or wired connection.

In a related aspect, a system control device can be installed on a computing device, such as a ruggedized laptop, in the cab of the truck, to allow the operator to control all operations of the universal mobile video surveillance system.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the universal mobile video surveillance system in an extended state, according to an embodiment of the invention.

FIG. 2 is a perspective view of the universal mobile video surveillance system in retracted state, according to an embodiment of the invention.

FIG. 3 is a perspective view of a universal tie-down component, according to an embodiment of the invention.

FIG. 4 is a perspective view of the universal mobile video surveillance system in a state ready for transfer to a truck bed, according to an embodiment of the invention.

FIG. 5 is a side view of the universal mobile video surveillance system in retracted state and mounted on a truck, according to an embodiment of the invention.

FIG. 6 is a side view of the universal mobile video surveillance system in an extended state and mounted on a truck, according to an embodiment of the invention.

FIG. 7 is a perspective view of the universal mobile video surveillance system in an extended state and mounted on a truck, according to an embodiment of the invention.

FIG. 8 is a front view of the universal mobile video surveillance system in retracted state and mounted on a truck, according to an embodiment of the invention.

FIG. 9 is a rear view of the universal mobile video surveillance system in retracted state and mounted on a truck, according to an embodiment of the invention.

FIG. 10 is a schematic diagram of the system control device, according to an embodiment of the invention.

FIG. 11 is a rear cross-sectional view of the lower part of universal mobile video surveillance system, according to an embodiment of the invention.

FIG. 12 is a rear cross-sectional view of the lower part of universal mobile video surveillance system, according to an embodiment of the invention.

FIG. 13 is a rear cross-sectional view of the lower part of universal mobile video surveillance system, according to an embodiment of the invention.

FIG. 14 is a rear cross-sectional view of the lower part of universal mobile video surveillance system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

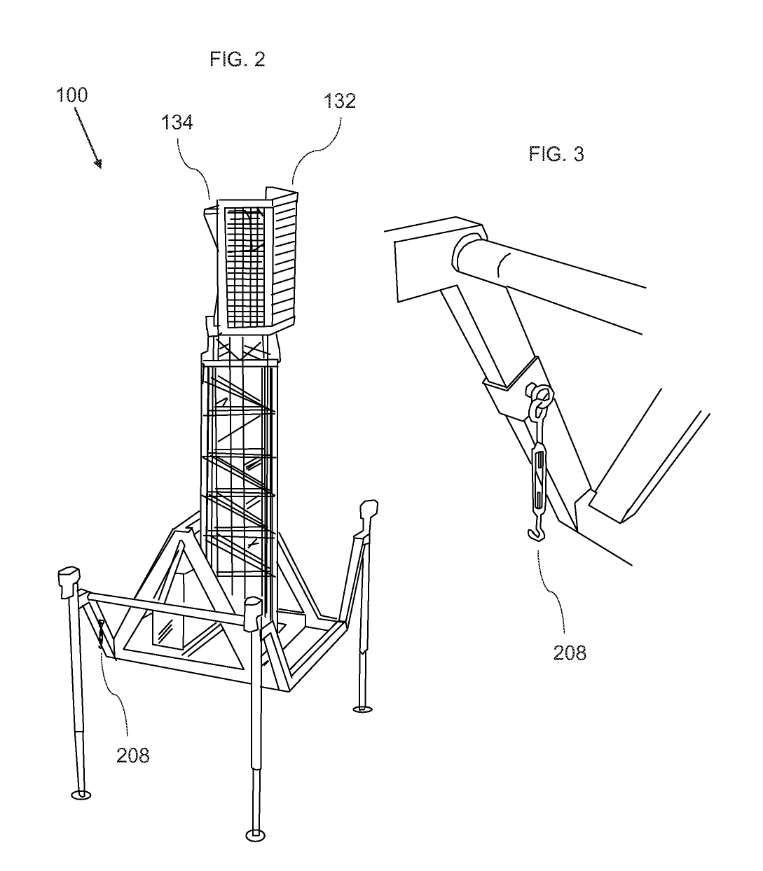

In the following, right and left, and front and rear shall be considered determined relative to the driving direction, and front and rear of a vehicle, such as the pickup truck 402, shown in FIG. 2.

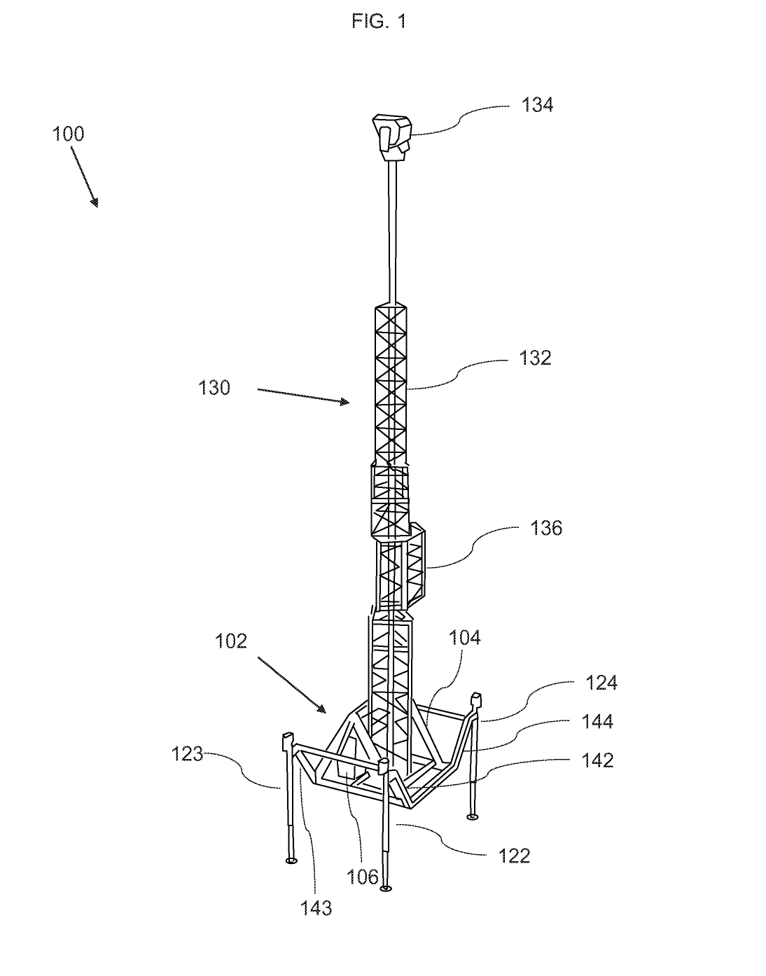

In the following, we describe the structure of an embodiment of a universal mobile video surveillance system 100, also referred to as the surveillance system 100, with reference to FIG. 1, in such manner that like reference numerals refer to like components throughout; a convention that we shall employ for the remainder of this specification.

In an embodiment, a universal mobile video surveillance system 100 for convenient mounting in a truck or other vehicle, can include:
a. A surveillance mast 130, which can further include:
   i. A mast structure 132, which can be telescopic;
   ii. A sensor unit 134, which for example can be a camera recording unit, optionally also fitted with lighting and audio recording capability, or some other type of sensor, such as a radar;
   iii. A guard 136, which can protect the sensor unit 134 during transportation, when the mast structure is retracted;
b. A sled 102, further comprising
   1. a sled frame 104;
   2. four outriggers 142 143 144 that extend outwards to the right and left sides from the sled frame; and
   3. a power and control unit 106;
   wherein the mast structure 132 is mounted inside the sled frame 104;
c. Leveling jacks 122 123 124, comprised of at least four individual leveling jacks, that can be adjusted in height, such that each of the leveling jacks 122 123 124 is mounted to a corresponding outrigger, which is mounted to one of the four corners of the sled frame 104;

Wherein, the leveling jacks and the outriggers are configured to allow the sled frame to be secured in a bed a of a truck, such that the outriggers extend outwards with sufficient clearance above any side panels of the truck, connecting with the leveling jacks which are positioned on the ground, with sufficient clearance to the side of the truck, whereby one operator can move the surveillance system 100 on and off the bed of a truck, by lifting and lowering the leveling jacks 122 123 124, and the leveling jacks 122 123 124, can also be used for additional stability when the surveillance system 100 is placed in the bed of a stationary truck, and the mast structure 132 is extended.

In relation to the above embodiment, FIG. 1 shows:
a. The front right leveling jack 122, which is connected via the front right outrigger 142, to the sled frame 104;
b. The rear right leveling jack 123, which is connected via the rear right outrigger 143, to the sled frame 104;
c. The front left leveling jack 123, which is connected via the rear right outrigger 143, to the sled frame 104.

The rear left leveling jack and the rear left outrigger are not visible in FIG. 1.

FIG. 2 illustrates an embodiment of the universal mobile video surveillance system 100 in a freestanding state, with the mast structure 130 retracted, the sensor unit 134 protected by the guard 136, and the leveling jacks 122 123 124 extended.

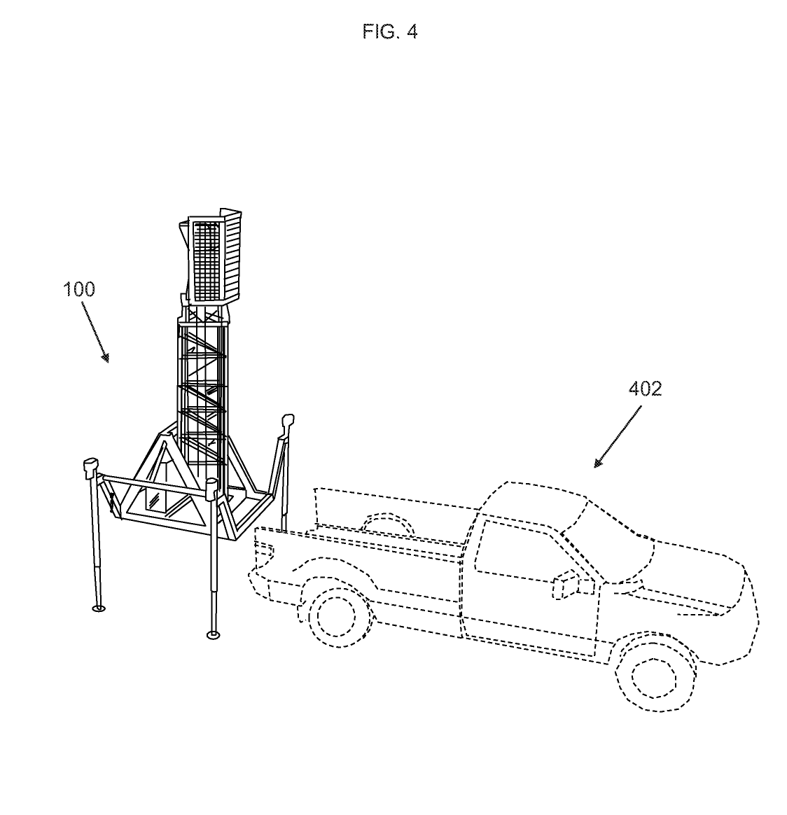

FIG. 4 illustrates the embodiment of the universal mobile video surveillance system 100 shown in FIG. 2, but further showing a pickup truck 402 ready to back up to position the sled 102 and the surveillance mast 130 over the bed of the truck, between the side panels, whereby thereafter the leveling jacks 120 can be lowered to secure the sled 102 and the surveillance mast 130 in the truck bed.

In related embodiments, the leveling jacks 120 can have a foot or pad structure for securing a firm contact with the ground, or can be fitted with heavy-duty caster wheels. Use of caster wheels can allow a sole operator to roll the universal mobile video surveillance system 100 onto a truck bed in a state as shown in FIGS. 2 and 4, so that the leveling jacks 120 thereafter can be lowered and the surveillance system 100 can be tied down and secured to the truck bed.

In related embodiments, the leveling jacks 120 can be configured with a wireless control component, or an attached control wire, that can control an electrical or mechanical lifting mechanism.

In related embodiments, the leveling jacks 120 can be configured with a manual lifting mechanism.

In related embodiments, the leveling jacks 120 can be designed for easy removal of extendable jack legs of the leveling jacks 120, for example via a standard pull pin mechanism.

In related embodiments, the leveling jacks 120 can allow for minor leveling adjustment when the surveillance system 100 is mounted on a truck, so that the surveillance mast 130 and sensor unit 134 can be leveled during operation, for example if the truck is parked on unleveled terrain.

In an embodiment, illustrated in FIGS. 2 and 3, the outriggers 142 143 144 and the sled frame 104 can further include universal tie-down components 208, which can be connected with mounts in the pick-up truck. Such a tie-down component can for example be a turnbuckle or a high-strength strap, or other suitable fastening mechanism. In some embodiments, there can be four tie-down components 208, each mounted to an outrigger 142 143 144. The sled frame 104 can further be designed to fit into a plurality of standard truck bed designs.

In related embodiments, the sled 102 can be designed to have a total weight of less than 900 lbs.

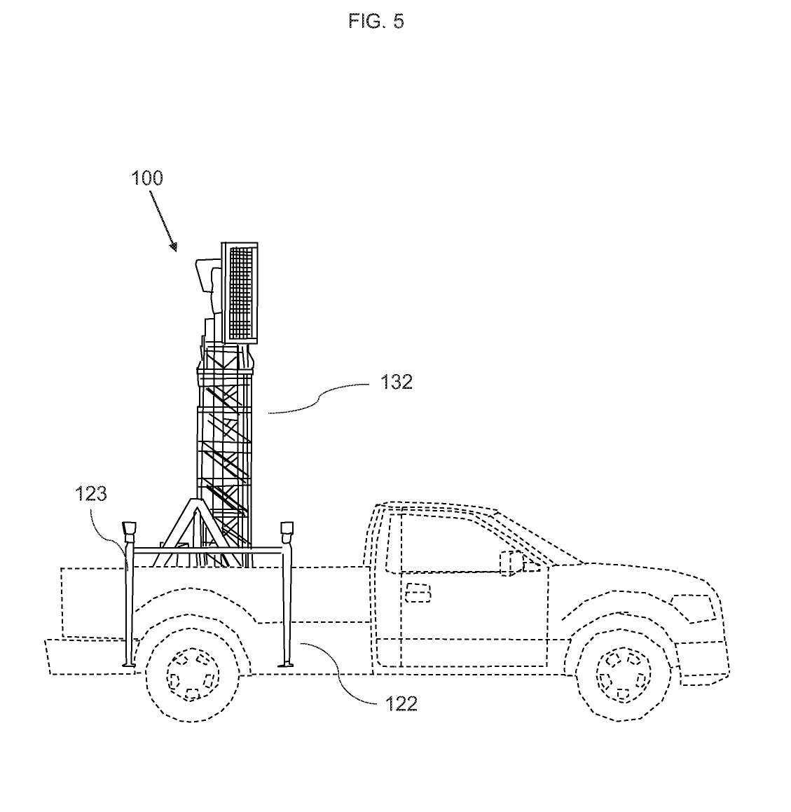

FIG. 5 illustrates an embodiment of the universal mobile video surveillance system 100, wherein the surveillance system 100 has been securely mounted in a truck, the mast structure 130 is in a retracted state, and the front right and rear right leveling jacks 122 123 are in a retracted state, so that the truck is ready for driving.

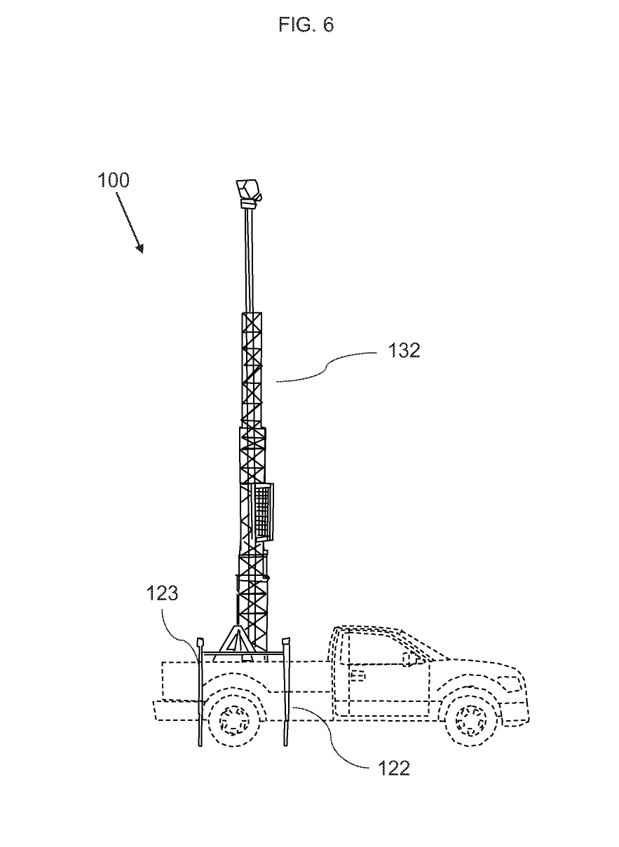

FIG. 6, shows a side view of an embodiment of the universal mobile video surveillance system 100, wherein the surveillance system 100 has been securely mounted in a truck, and the mast structure 130 is in an extended state, and the front right and rear right leveling jacks 122 123 are in an extended state with contact to the ground for maximum stability, for use during surveillance operations, when the truck is stationary.

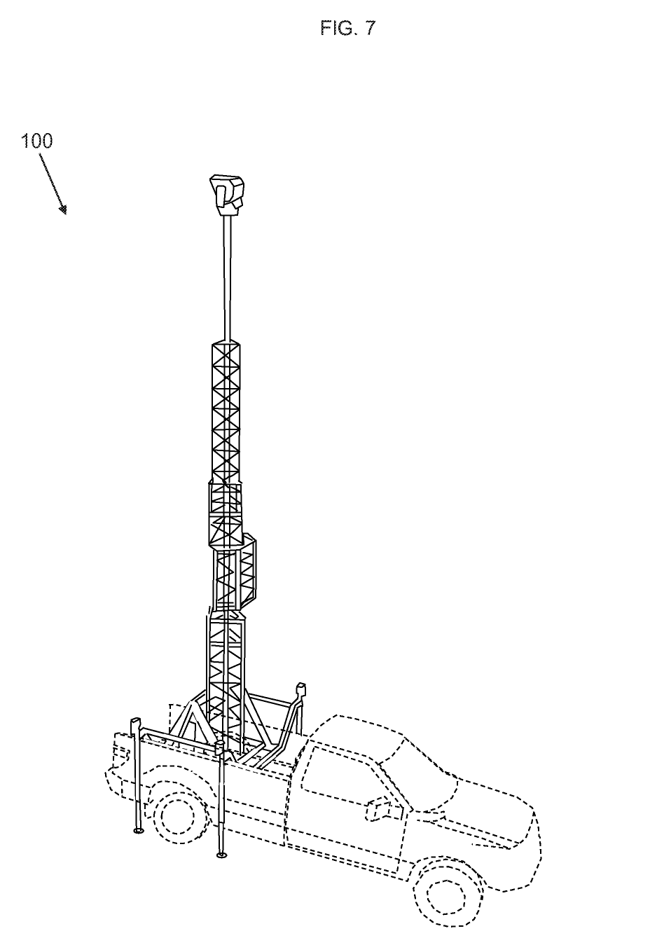

FIG. 7 shows a perspective view of the embodiment shown in FIG. 5.

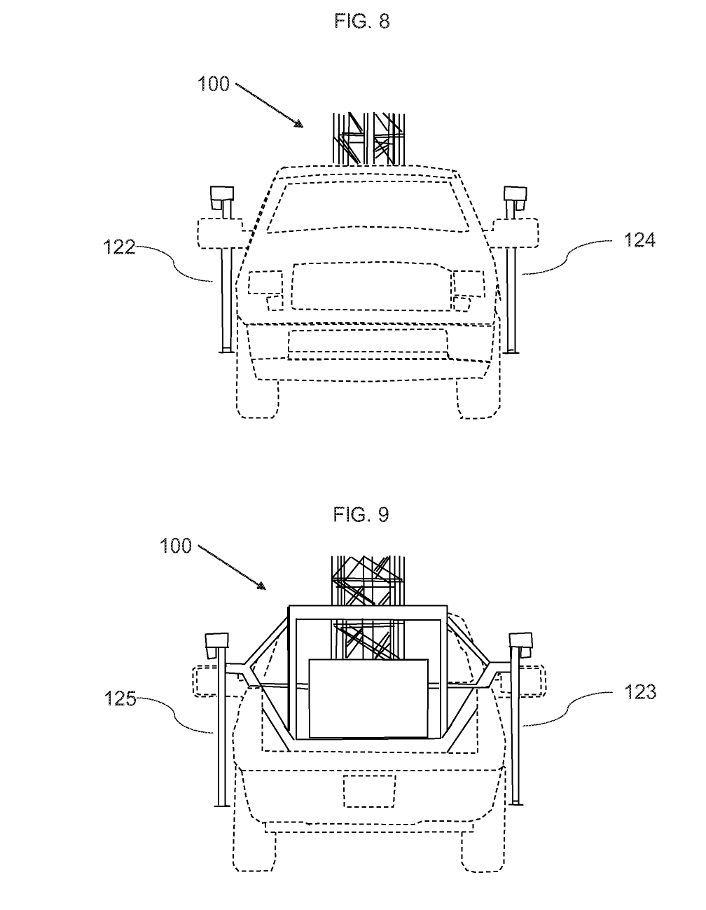

FIGS. 8 and 9 show respectively a front and rear view of the embodiment shown in FIG. 5, to illustrate that the leveling jacks 122 123 124 125 can be positioned close to the truck, where they will not pose a hazard during normal driving.

In related embodiments, the mast structure 132 can be constructed from well-known and generally available telescopic mast systems. The mast structure 132 may employ a pulley system, a gear system, a screw-drive system, a pneumatic or hydraulic system, or other form of mechanical or electromechanical system to extend or retract the mast. The mast structure 132 can be constructed as a telescopic lattice structure, a telescopic tubular structure, or other common telescopic mast structures, and may further be remote controllable via a wireless or wired connection.

In related embodiments, the mast structure 132 can be capable of lifting more than a 100-pound payload.

In various embodiment the mast structure 132 can extend to 30 feet or more for superior visibility, and can be retracted to a height of less than 13 feet when mounted on a vehicle.

In various embodiments, the surveillance system 100 can be designed to be capable of operation in 75 mph sustained winds.

In a related embodiment, the power and control unit 106, can include:
a. a battery to operate various equipment, including for example engines or pressure systems, for the jacks 120 and mast structure 132; and
b. a wireless router and antenna, to establish local wireless networking for control and operation of the jacks 120, the mast structure 132, and the sensor unit 134.

In an embodiment, the surveillance mast 120 can further comprise a high-power line detector, to avoid raising the mast into a power line.

In various embodiments, the mobile video surveillance system 100 can be designed to provide a simple yet versatile and configurable system capable of surviving extreme environments, with ruggedized components to survive the harshest environments, off-road or on paved roads.

In various embodiments, the mobile video surveillance system 100 can fit into a variety of standard pickup trucks and other types of flatbed trucks.

In various embodiments, the mobile video surveillance system 100 can be transferred quickly and easily between vehicles by only one operator, without the use of special tooling or other equipment.

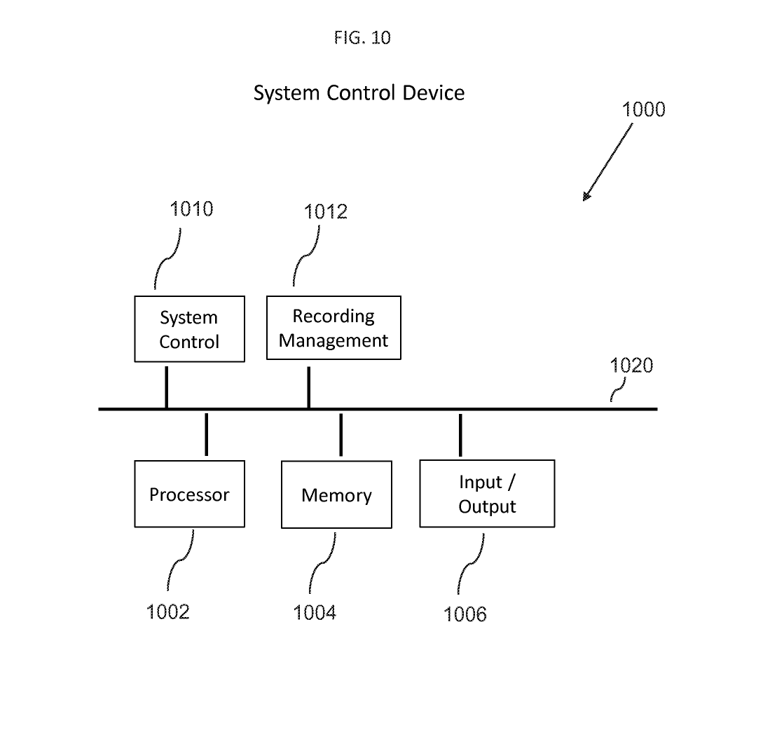

In an embodiment, illustrated in FIG. 10, the mobile video surveillance system 100 can further include a system control device 1010, which can include
a. A processor 1002,
b. A memory 1004,
c. An input/output component 1006,
d. A system controller 1010,
e. A recording management component 1012, all connected via a
f. Data bus 1020;
Wherein
the system controller 1010 can connect via wired or wireless network connections to the sensor unit 134, the mast structure 134, the leveling jacks 120, and the power and control unit 106, in order to control the functions of these components; and
the recording management component 1012 can manage recording, display, analysis and storage of video, audio, and other sensor information from the sensor unit 134.

In a related embodiment, the system control device 1000 can be installed on a computing device in the cab of a truck, wherein the computing device for example can be a vehicle-embedded computer, such as a Linux computer, or it can be a rugged laptop computer mounted in the cab of the truck. Such a mobile laptop installation can be done with common installation methods that do not require permanent modification of the vehicle, and can fit into fits into a variety of trucks and other vehicles.

In a related embodiment, the recording management component 1012 can provide integrated video viewing, recording and tagging, and can provided integrated management, analysis, and reporting of all sensor information available from systems in the mobile video surveillance system 100, whereby all operational, camera, mast and outrigger controls can be consolidated onto a laptop for full system operation without leaving the cab of the vehicle

In a related embodiment, the recording management component 1012 can export video and other stored sensor information in encrypted and password protected formats that are compliant with common security standards.

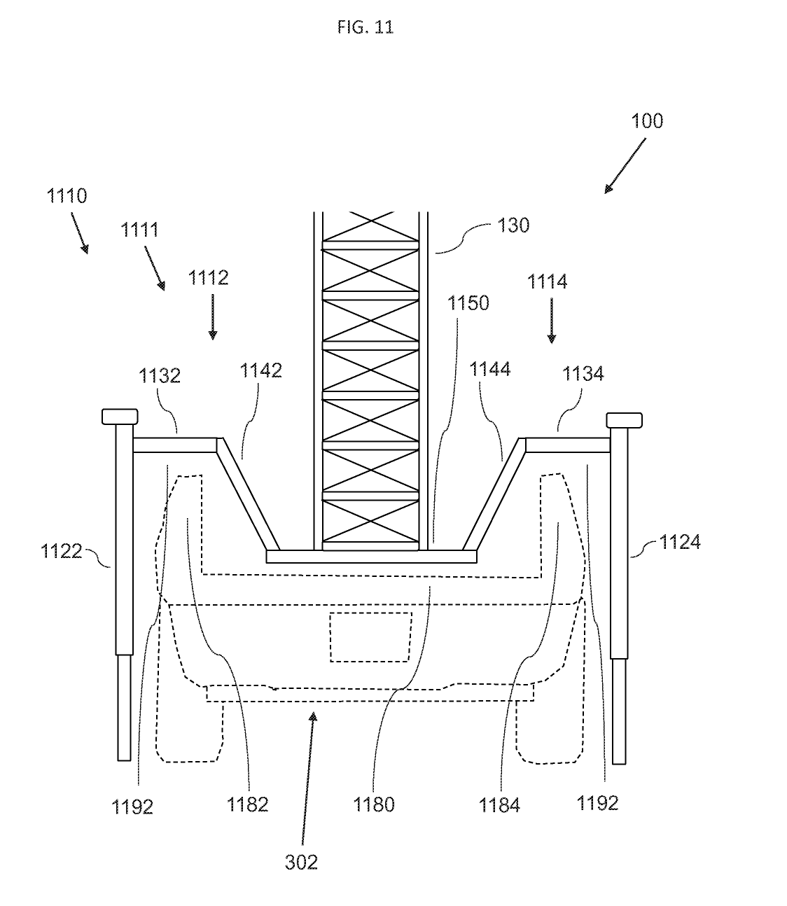

In an embodiment, of which a rear view is illustrated in FIG. 11, a universal mobile video surveillance system 100, can comprise a support structure 1110 which is connected to and carries a surveillance mast 1160, wherein the support structure 1110 is configured in a double-arch shape, forming respectively right and left elongated cavities 1192 1194, extending from front to rear under respectively right and left arches of the support structure 1110, and wherein further the height of the support component can be adjusted,

whereby a pickup truck 402 with any tailgate in an open and flat configuration, can be driven under the support component, when the support structure 1110 is adjusted to a sufficient height, and right and left side panels 1182 1184 of the pickup truck 402 can fit in respectively the right and left elongated cavities 1192 1194.

In a related embodiment, the support structure 1110, can comprise:
a. A right outer support component 1122, wherein the height of the right outer support component 1122 can be adjusted;
b. A center support component 1111, which can be further comprised of the following connected components:
   i. A right middle support component 1112, which can be further comprised of connected components:
      1. A right lintel 1132, which forms the upper part of the right arch; and
      2. A right inner support component 1142,
   ii. A base support component 1150; wherein the base component is mounted to and carries the surveillance mast 1160;
   iii. A left middle support component 1114, which can be further comprised of:
      1. A left lintel 1134, which forms the upper part of the left arch,
      2. A left inner support component 1144,
c. A left outer support component 1124, wherein the height of the left outer support component 1124 can be adjusted;

In related embodiments, the support structure 1110, can lift and lower the surveillance mast 130, when the support component is positioned on a ground surface, and the height levels are adjusted of both the right outer support component 1122 and the left outer support component 1124, whereby:
i. a flat bed of a truck or other vehicle, can be backed up under the surveillance mast 130 from the front of the surveillance mast 130, when the surveillance mast 130 has been lifted sufficiently; after which
ii. the surveillance mast 130 can be lowered until it is firmly positioned on the flat bed, after which
iii. the right and left outer support components 1122 1124 can be lifted from the ground by further lowering operation of the lifting component, so that
iv. the surveillance mast 130 becomes firmly secured in the flat bed, with the lifting component cleared from the ground surface, allowing the vehicle to drive with the universal mobile video surveillance system securely mounted in the flat bed of the vehicle.

In a related embodiment, illustrated in FIG. 1, the right outer support component 1122, can be further comprised of at least two leveling jacks, a front right leveling jack 122, and a rear right leveling jack 123, and correspondingly the left outer support component 1122, can be further comprised of at least two leveling jacks, a front left leveling jack 124, and a rear left leveling jack 125.

In another related example embodiment, both the right and left lifting components can be respectively comprised of a plate structure, either solid or in a wireframe or lattice configuration, which is configured to lift or lower the mast component, for example using one or more rack and pinion gears on connected plate sub-structures.

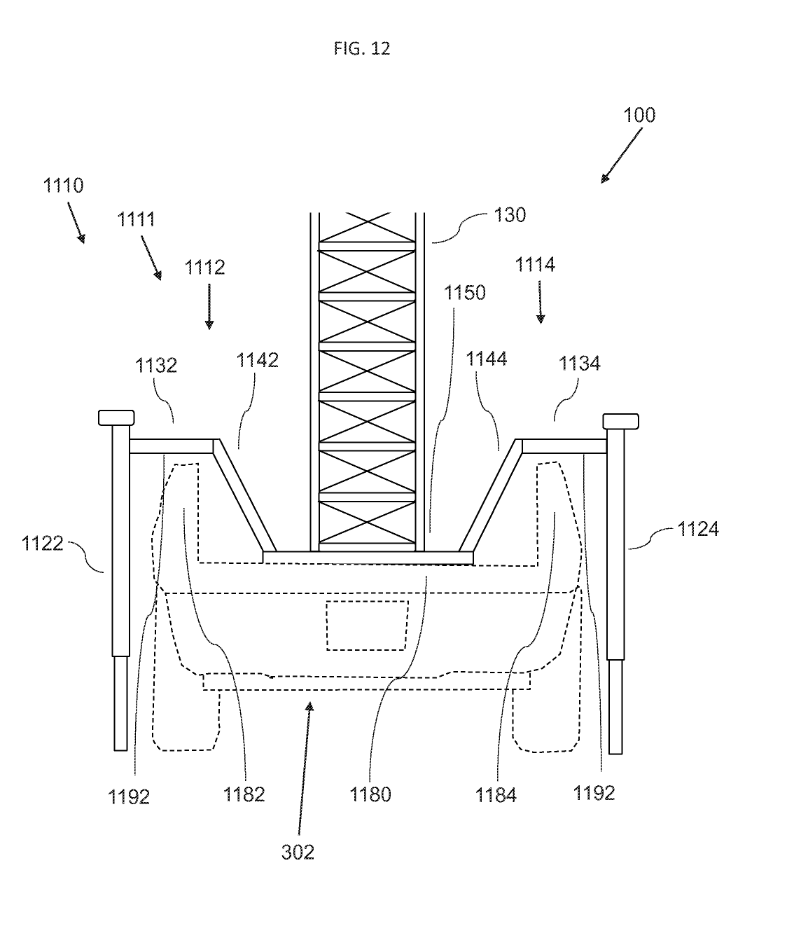

FIG. 12 shows an embodiment of the universal mobile video surveillance system 100, in a lowered state, so that the center support component 1150 is positioned in the bed 1180 of the truck 402.

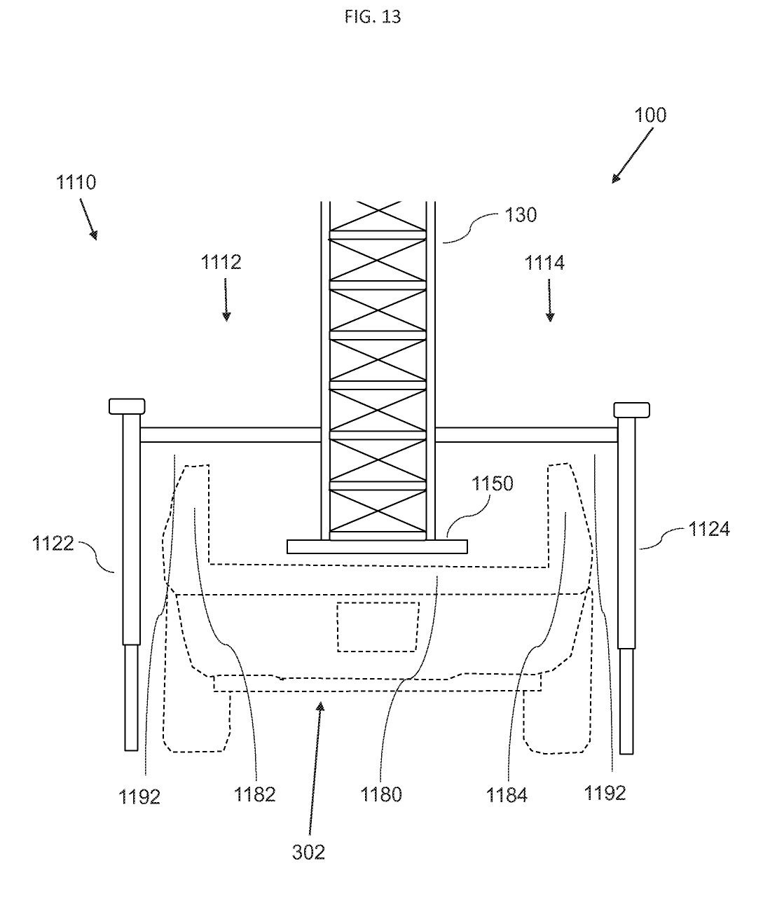

Many other embodiments are possible, which exhibit different variants of the support structure 1110, wherein the support component is configured in a double-arch shape. For example, in an alternative embodiment shown in FIG. 13, the right and left middle support components 1112 1114, can connect directly between respectively the right and left outer support components 1122 1224 and the surveillance mast 130, whereby the lower part of the surveillance mast 130 replaces the function of both the right and left inner support components 1142 1144.

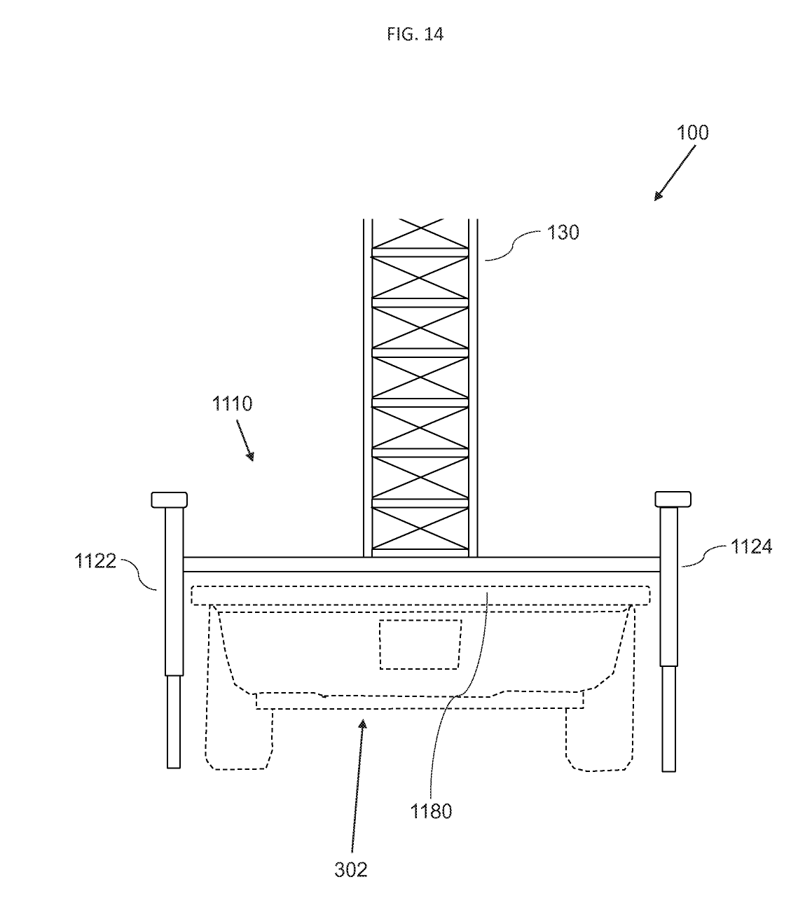

In another alternative embodiment, shown in FIG. 14, the support structure 1110 is shaped as a flat bridge extending underneath the surveillance mast, connecting between the right and left outer support components 1122 1224. This embodiment can for example be suitable for installation on large flatbed trucks that do not have side panels, and can be viewed as an embodiment with a flattened double-arch, where the left and right lintels 1132 1134, the right and left inner support components 1142 1144, and the center support component 1150, are at the same level and replaced by one integral component.

In an embodiment, a method for transferring a mobile video surveillance system onto the bed of a truck can comprise:
a. Placing the mobile video surveillance system on the ground with a mast in a retracted state;
b. Adjusting the height of the underside of a sled holding the mast, by adjusting the height level of leveling jacks mounted via outriggers to the sled;
c. Placing the bed of the truck underneath the sled, by either
   i. Backing up the truck until the sled is over the center of the bed of the truck; or
   ii. Rolling the sled and mast over the bed of the truck, utilizing caster rollers mounted to the outriggers;
d. Lowering the sled onto the bed of the truck, by adjusting the height level of the leveling jacks;
e. Securing the sled to the truck, by attaching and tightening tie-down clamps to mounts in the bed of the truck;
f. Raising the mast, to prepare for surveillance operations; and optionally
g. Lowering the leveling jacks to the ground, for added stability.

FIG. 10 is a block diagram of devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIG. 10 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the system control device 1000 are to be interpreted in the most general manner.

For example, the processor 1002 can include a single physical microprocessor or microcontroller, a cluster of processors, a datacenter or a cluster of datacenters, a computing cloud service, and the like.

In a further example, the memory 1004 can include various forms of non-transitory storage media, including random access memory and other forms of dynamic storage, and hard disks, hard disk clusters, cloud storage services, and other forms of long-term storage. Similarly, the input/output 1006 can include a plurality of well-known input/output devices, such as screens, keyboards, pointing devices, motion trackers, communication ports, and so forth.

Furthermore, it shall be understood that the system control device 1000 can include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the system control device 1000 communicates with the sensor unit 134, the mast structure 134, the leveling jacks 120, and the power and control unit 106 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can optionally be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A universal mobile video surveillance system for convenient mounting in a truck or other vehicle, comprising:
a) a surveillance mast;
b) a sled; further comprising a sled frame and at least four outriggers, including:
a front right outrigger, extending outwards to the right side of the sled frame, and connected with the front right corner of the sled frame;
a rear right outrigger, extending outwards to the right side of the sled frame, and connected with the rear right corner of the sled frame;
a front left outrigger, extending outwards to the left side of the sled frame, and connected with the front left corner of the sled frame;
a rear left outrigger, extending outwards to the left side of the sled, and connected with the rear left corner of the sled frame;
wherein the surveillance mast is mounted in the sled frame;
c) leveling jacks, comprised of at least four leveling jacks, including:
a front right leveling jack connected with the front right outrigger;
a rear right leveling jack connected with the rear right outrigger;
a front left leveling jack connected with the front left outrigger;
a rear left leveling jack connected with the rear left outrigger;
wherein the leveling jacks and the outriggers are configured to allow the sled frame to be secured in a bed a of the truck, such that the outriggers extend outwards with sufficient clearance above any side panels of the truck, connecting with the leveling jacks, which are positioned on the ground, with sufficient clearance to the side of the vehicle, whereby one operator can move the surveillance system on and off the bed of a truck, by lifting and lowering the leveling jacks, and the leveling jacks can also be used for additional stability when the surveillance system is placed in the bed of a stationary truck, and the mast structure is extended.

2. The universal mobile video surveillance system of claim 1, wherein the surveillance mast further comprises:
a) a mast structure; and
b) a sensor unit;
wherein the sensor unit can be mounted on the top of the mast structure.

3. The universal mobile video surveillance system of claim 2, wherein the mast structure is telescopic, whereby the mast structure can be extended during surveillance operations, and can be retracted during storage or during transportation on a truck.

4. The universal mobile video surveillance system of claim 3, wherein the surveillance mast further comprises a guard, wherein the sensor unit will shield the front side of the sensor unit when the mast is in a retracted state, whereby the guard can shield and protect the sensor unit during transportation.

5. The universal mobile video surveillance system of claim 1, further comprising a power and control unit, which comprises a battery to provide power to components of the mobile video surveillance system, and a wireless router and antenna.

6. The universal mobile video surveillance system of claim 1, wherein the leveling jacks further comprise caster wheels, whereby the caster wheels can allow a sole operator to roll the universal mobile surveillance system onto the bed of the truck.

7. The universal mobile video surveillance system of claim 1, wherein the sled frame further comprises at least one universal tie-down component, whereby the universal tie-down component can be connected with a mount in the bed of the truck, and tightened to secure the universal mobile video surveillance system in the bed of the truck.

8. The universal mobile video surveillance system of claim 1, further comprising a system control device, comprising:
a) a processor;
b) a non-transient memory;
c) an input/output component; and
d) a system controller;
wherein the system controller is connected via a network connection to connected components, including the sensor unit, the mast structure, the leveling jacks, and the power and control unit, whereby the operator can control the functions of these components.

9. The universal mobile video surveillance system of claim 8, further comprising a recording management component, wherein the recording management component is configured to manage recording, display, analysis and storage of video, audio, and other sensor information from the sensor unit.

10. The universal mobile video surveillance system of claim 9, wherein the recording management component is configured to store and export sensor information in an encrypted and password protected format.

11. A universal mobile video surveillance system, comprising:
a) a support structure; and
b) a surveillance mast, wherein the support structure is connected to and carries the surveillance mast;
wherein the support structure is configured in a double-arch shape, forming respectively right and left elongated cavities, extending from front to rear under respectively right and left arches of the support structure, and wherein further the height of the support component can be adjusted, whereby a pickup truck with any tailgate in an open and flat configuration, can be driven under the support component, when the support structure is adjusted to a sufficient height, and right and left side panels of the pickup truck can fit in respectively the right and left elongated cavities.

12. The universal mobile video surveillance system of claim 11, wherein the support structure further comprises:
a) a right outer support component, wherein the height of the right outer support component can be adjusted;
b) a center support component, further comprised of connected components:
A right middle support component;
A base support component; wherein the base component is mounted to and carries the surveillance mast;
A left middle support component;
c) A left outer support component, wherein the height of the left outer support component can be adjusted;
wherein the support structure, can lift and lower the surveillance mast, when the right and left out support components are positioned on a ground surface, and the height levels are adjusted for both the right outer support component and the left outer support component.

13. The universal mobile video surveillance system of claim 12, wherein:
the right middle support component is further comprised of a right lintel connected with a right inner support component; and
the left middle support component is further comprised of a left lintel connected with a left inner support component.

14. The universal mobile video surveillance system of claim 11, wherein the surveillance mast further comprises:
a) a mast structure; and
b) a sensor unit;
wherein the sensor unit can be mounted on the top of the mast structure.

15. The universal mobile video surveillance system of claim 14, wherein the mast structure is telescopic, whereby the mast structure can be extended during surveillance operations, and can be retracted during storage on the ground or during transportation on a truck.

16. The universal mobile video surveillance system of claim 12, wherein both the right and left outer support component each further comprise at least two caster wheels, whereby the caster wheels can allow a sole operator to roll the universal mobile surveillance system onto the bed of the truck.

17. The universal mobile video surveillance system of claim 11, wherein the support structure is shaped as a flat bridge extending underneath and connected to the surveillance mast, such that the support structure connects between the right and left outer support components, whereby the universal mobile video surveillance system can be used for operation on flatbed trucks that do not have side panels.

18. A method for transferring a mobile video surveillance system onto the bed of a truck can comprise:
a) placing the mobile video surveillance system on the ground with a surveillance mast in a retracted state;
b) adjusting the height of the underside of a sled holding the surveillance mast, by adjusting the height level of leveling jacks mounted via outriggers to the sled;
c) placing the bed of the truck underneath the sled;
d) lowering the sled onto the bed of the truck, by adjusting the height level of the leveling jacks;
e) securing the sled to the truck, by attaching and tightening tie-down clamps to mounts in the bed of the truck;
f) raising the surveillance mast, to prepare for surveillance operations; and optionally
g) lowering the leveling jacks to the ground, for added stability.

19. The method for transferring a mobile video surveillance system onto the bed of a truck of claim 18, wherein the act of placing the bed of the truck underneath the sled, further comprises backing up the truck, under the surveillance mast, until the sled is over the center of the bed of the truck.

20. The method for transferring a mobile video surveillance system onto the bed of a truck of claim 18, wherein the act of placing the bed of the truck underneath the sled, further comprises rolling the sled and mast over the bed of the truck, utilizing caster rollers mounted to the leveling jacks.
